(19) United States
(12) Patent Application Publication
(10) Pub. No.: US 2010/0255275 A1
(43) Pub. Date: Oct. 7, 2010

(54) Magenta Dyes and Inks for Use in Ink-Jet Printing

(76) Inventors: Gavin Wright, Manchester (GB); Toshiki Fujiwara, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 12/679,825

(22) PCT Filed: Sep. 3, 2008
(86) PCT No.: PCT/GB08/02971

§ 371 Date: Apr. 28, 2010

(30) Foreign Application Priority Data
Sep. 29, 2007 (GB) 0719083.8

(51) Int. Cl. C09D 11/02; C09B 29/06; B32B 3/10; B41J 2/175

(52) U.S. Cl. 428/211.1; 534/737; 106/31.45; 428/195.1; 347/100; 347/86

(57) ABSTRACT

A compound of Formula (1) and salts thereof:

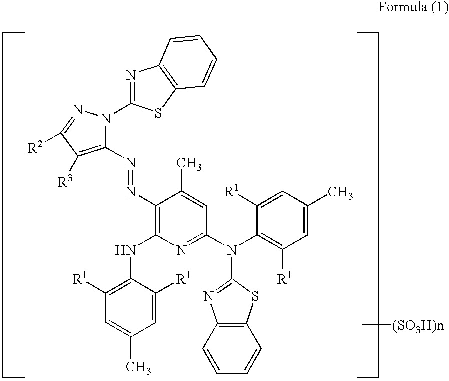

wherein:
R¹ is optionally substituted C₁₋₄alkyl;
R² is optionally substituted aryl;
R³ is CN or SO₂R⁴;
R⁴ is optionally substituted C₁₋₄-alkyl or optionally substituted aryl;
n is 1 to 5.
also ink-jet compositions, processes and printed material.

This invention relates to dyes, to compositions and inks for ink-jet printers, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras and ink-jet printers it is becoming increasingly common for consumers to print off photographs using an ink-jet printer.

While ink-jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid sheets sticking together after they have been printed, but they should not form a crust over the tiny nozzles in the printer head. Storage stability is also important to avoid particle formation that could block the tiny nozzles used in the printer especially since consumers can keep an ink-jet ink cartridge for several months. Furthermore, and especially important with photographic quality reproductions, the resultant images should not bronze or fade rapidly on exposure to light or common oxidising gases such as ozone. It is also important that the shade and chroma of the colorant are exactly right so that an image may be optimally reproduced.

Thus developing new colorants for ink-jet printing presents a unique challenge in balancing all these conflicting and demanding properties.

The present invention provides a compound of Formula (I) and salts thereof:

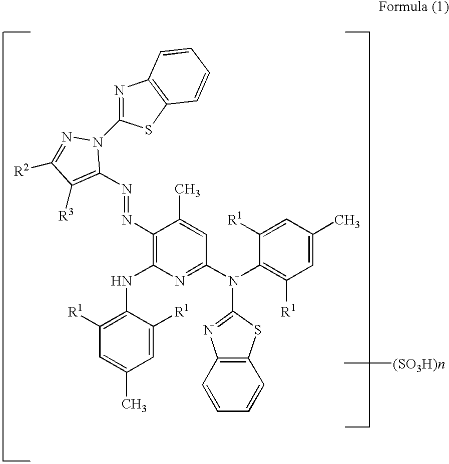

wherein:

R¹ is optionally substituted C₁₋₄alkyl;

R² is optionally substituted aryl;

R³ is CN or SO₂R⁴;

R⁴ is optionally substituted C₁₋₄-alkyl or optionally substituted aryl;
n is 1 to 6.

Optional substituents which may be present on R¹, R² or R⁴ are preferably independently selected from: optionally substituted alkenyl (preferably optionally substituted C₁₋₄-alkenyl), optionally substituted alkynyl (preferably optionally substituted C₁₋₄-alkynyl), optionally substituted alkoxy (preferably optionally substituted C₁₋₄-alkoxy), optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —NH—R^{a}, wherein R^{a}, R^{b} and R^{c} are each independently H, optionally substituted aryl (especially optionally substituted phenyl) or optionally substituted alkyl (especially optionally substituted C₁₋₄-alkyl). R² and R⁴, when it is aryl, may also be optionally substituted by optionally substituted alkyl (preferably optionally substituted C₁₋₄-alkyl). Optional substituents for any of the above substituents may be selected from the same list of substituents.

R¹ is preferably unsubstituted C₁₋₄alkyl and more preferably methyl or ethyl.

R² is preferably optionally substituted phenyl or optionally substituted naphthyl, more preferably R² is optionally substituted phenyl especially phenyl carrying optional substituents selected from the group consisting of F, Cl, NO₂, CN, CF₃, —SO₂R⁸, —SO₂NR^{a}R^{b} wherein R^{a} and R^{b} are each independently H, optionally substituted alkyl (especially optionally substituted C₁₋₄-alkyl) or optionally substituted aryl (especially optionally substituted phenyl).

R⁴ is preferably optionally substituted C₁₋₄-alkyl or optionally substituted phenyl.

n is preferably 3 or 4.

The compounds of Formula (I) are also preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups excluded from the compounds of Formula (1) there may be mentioned aliphatic sulfonyl groups which contain a sulfate ester group in beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring, for example a triazinyl halide.

Acid and basic groups on the compounds of Formula (1), particularly acid groups, are preferably in the form of a salt. Thus, the Formulae shown herein include the compounds in free acid and in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts. The compounds of Formula (1) may be converted into a salt using known techniques.

The compounds of Formula (1) may exist in tautomeric forms other than those shown in this specification. These tautomers are included within the scope of the present invention. However, tautomers may not bear a substituent on the hydroxy/enol oxygen.

Preferred compounds of Formula (1) may be prepared using those processes described in U.S. Pat. No. 7,108,743, which is incorporated herein by reference.

The compounds of Formula (1) have attractive, strong magenta shades and are valuable colorants for use in the preparation of ink-jet printing inks. They benefit from a good balance of solubility, storage stability and fastness to ozone and light. In particular they display excellent ozone fastness.

According to a second aspect of the present invention there is provided a composition comprising a compound of Formula (1) and/or a salt thereof, as described in the first aspect of the invention, and a liquid medium.

Preferred compositions according to the second aspect of the invention comprise:
(a) from 0.01 to 30 parts of a compound of Formula (1) and salts thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties. Examples of such colorants include C.I. Direct Yellow 86, 132, 142 and 173; C.I. Direct Blue 307; C.I. Food Black 2; C.I. Direct Black 168 and 195; and C.I. Acid Yellow 23.

It is preferred that the composition according to the invention is ink suitable for use in an ink-jet printer. Ink suitable for use in an ink-jet printer is ink which is able to repeatedly fire through an ink-jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying a composition, preferably ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred. Photographic quality papers are especially preferred. Photographic quality paper are high-gloss papers which give a similar finish to that typically seen with silver halide photo printing.

A fourth aspect of the present invention provides a material preferably paper, plastic, a textile, metal or glass, more preferably paper, an overhead projector slide or a textile material, especially paper more especially plain, coated or treated papers printed with a compound as described in the first aspect of the invention, a composition according to the second aspect of the invention or by means of a process according to the third aspect of the invention.

It is especially preferred that the printed material of the fourth aspect of the invention is a print on a photographic quality paper printed using a process according to the third aspect of the invention.

A fifth aspect of the present invention provides an ink-jet printer cartridge comprising a chamber and a composition, preferably ink suitable for use in an ink-jet printer, wherein the composition is in the chamber and the composition is as defined and preferred in the second aspect of the present invention. The cartridge may contain a high concentration ink and a low concentration ink, as described in the second aspect of the invention, in different chambers.

### EXAMPLE 1

### Preparation of

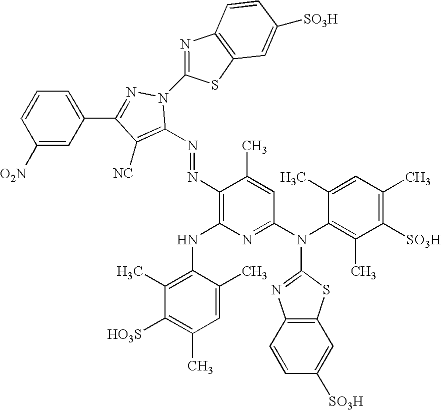

### Stage (a)

### Preparation of Intermediate (1a)

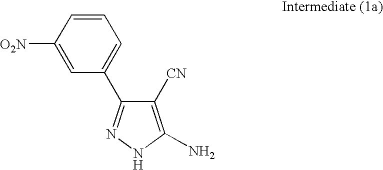

Trethylamine (101 g, 1.0 mol) was added drop-wise to a mixture of malononitrile (33 g, 0.50 mol) and 3-nitrobenzoyl chloride (93 g, 0.50 mol) in toluene (500 ml) at 25-30° C. The reaction mixture was stirred at 20° C. for 16 hours and then evaporated under reduced pressure. The resulting residue was stirred in a mixture of dichloromethane (500 ml) and 1N sulphuric acid (500 ml), the organic phase was separated, dried over MgSO₄ and evaporated under reduced pressure to give an oil. Sodium hydrogen carbonate (208 g, 2.5 mol) was added to a solution of the above oil in tetrahydrofuran (500 ml), to this stirred suspension was slowly added dimethyl sulphate (48 ml, 0.50 mol). The reaction mixture was stirred at reflux for 3 hours and then evaporated under reduced pressure. Hydrazine monohydrate (25 ml, 0.50 mol) was added drop-wise to a solution of the above residue in propan-2-ol (250 ml) at 30-40° C. The reaction mixture was stirred for 2 hours at 70° C., allowed to cool and added to water (4000 ml). The resultant precipitate slowly solidified and was collected by filtration. The crude product was purified by re-crystallisation from propan-2-ol (200 ml) to give 25 g of a yellow solid.

### Stage (b)

### Preparation of Intermediate (1b)

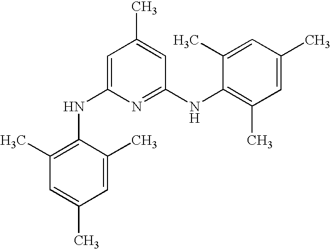

Intermediate (1b) was prepared according to the method described in WO 2002/083795.

### Stage (c)

### Preparation of Intermediate (1c)

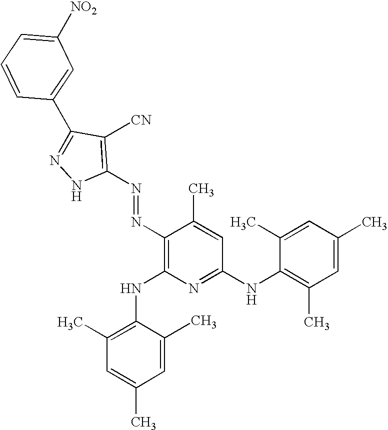

Concentrated hydrochloric acid (30 ml) was added to a mixture of intermediate (1a) (11.5 g, 0.05 mol), intermediate (1b) (23 g, 0.05 mol), acetonitrile (75 ml) and acetic acid (75 ml) to give a reaction mixture. A solution of NaNO₂ (3.5 g, 0.05 mol) in water (10 ml) was added drop-wise to the above reaction mixture at 0-5° C., the reaction mixture was stirred for 2 hours at 5-20° C. and then added slowly to water (2000 ml). The resultant precipitate was collected by filtration, washed with water (500 ml) and dried in a desiccator to give 40 g of an orange solid.

### Stage (d) Preparation of Intermediate (1d)

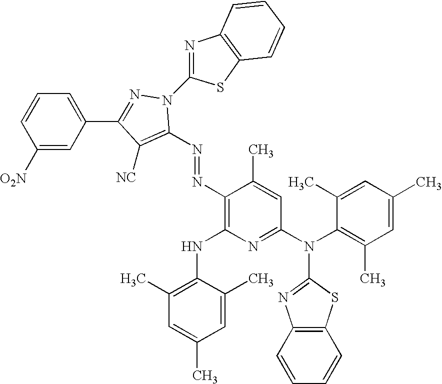

A mixture of intermediate (1c) (39.0 g, 0.065 mol), 2-chlorobenzothiazole (44.2 g, 0.26 mol), tetrabutylammonium bromide (2.1 g, 0.0065 mol), potassium carbonate (36 g) and dimethylsulfoxide (75 ml) was stirred in an atmosphere of nitrogen at 70° C. for 16 hours. The reaction mixture was diluted with dimethylsulfoxide (100 ml), the crude product collected by filtration and washed with dimethylsulfoxide (50 ml) and then methanol (200 ml). The filtered solid was stirred in water (500 ml), collected by filtration, washed with water (2×100 ml) and dried to give 7.9 g of a dark red solid.

### Stage (e)

### Preparation of the Title Dye

Intermediate (1d) (7.5 g, 0.0087 mol) was added in portions to 20% oleum (50 ml) at 15-20° C. The reaction mixture was stirred at 20° C. for 45 minutes and then drowned into ice cold water (1000 ml), the resultant precipitate was collected by filtration and then redissolved in water (300 ml). The solution was neutralised with NaOH, dialysed to low conductivity and dried at 60° C. to give 5.1 g of a dark red solid.

### EXAMPLES 2-5

Examples 2-5 were prepared following the method of Example 1 except that in Stage (a) in place of 3-nitrobenzoyl chloride the benzoyl chlorides shown in the Table were used to give dyes as in Example 1 except that in the R² position the nitrophenyl is replaced by the phenyl radical as shown below.

| Example | R² | Benzoyl chloride |
|---|---|---|
| Dye (2) | 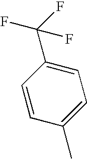 | 4-trifluoromethyl benzoyl chloride |
| Dye (3) | 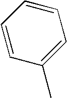 | benzoyl chloride |
| Dye (4) | 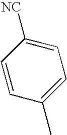 | 4-cyanobenzoyl chloride |
| Dye (5) | 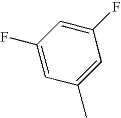 | 3,5-difluorobenzoyl chloride |
| Dye (6) | 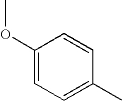 | 4-methoxybenzoyl chloride |
| Dye (7) | 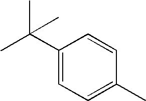 | 4-tertbutylbenzoyl chloride |
| Dye (8) | 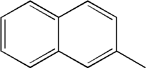 | 2-naphthoyl chloride |

### COMPARATIVE EXAMPLE

Example dye F1 from U.S. Pat. No. 7,108,743 was used as a comparative example:

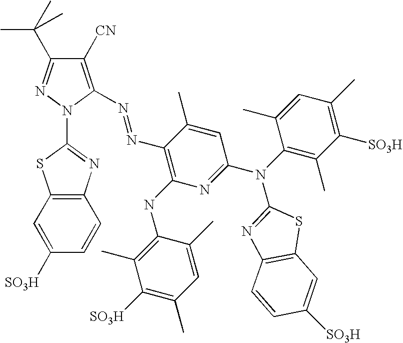

### EXAMPLE 4

### Preparation of Inks

Example Ink and a Comparative Ink was prepared by dissolving 3.2 g of the dye of Example 1 or the Comparative Example dye in a liquid medium comprising (% by weight):

| | |
|---|---|
| Diethyleneglycol | 7% |
| 2-Pyrollidone | 7% |
| Ethyleneglycol | 7% |
| Surfynol ™ 465 | 1% |
| Tris buffer | 0.2% |
| Water | 77.8% |

Surfynol ™ 465 is a surfactant from Air Products.

### EXAMPLE 5

### Ink-Jet Printing

Ink prepared as described above was filtered through a 0.45 micron nylon filter and then incorporated into empty print cartridges using a syringe.

This was then printed on to the following ink-jet media at 50% depth;

Epson Ultra Premium Glossy Photo Paper (SEC PM); and

Canon Premium PR101 Photo Paper (PR101)

HP Advanced Photo Paper (HPP).

The resultant prints were tested for ozone fastness by exposure to 5 ppm ozone at 25° C., 50% relative humidity for 24 hours in a Hampden 903 Ozone cabinet. Fastness of the printed ink to ozone can be judged by the difference in the optical density before and after exposure to ozone.

Optical density measurements can be performed using a Gretag spectrolino spectrophotometer set to the following parameters:

Measuring Geometry: 0°/45°

Spectral Range: 380-730 nm

Spectral Interval: 10 nm

Illuminant: D50

Observer: 2° (CIE 1931)

Density: Ansi A

External Filler: None

Ozone fastness was assessed by the percentage change in the optical density of the print, where a lower figure indicates higher fastness. The results are shown below

| | % OD Loss | % OD Loss | % OD Loss |
|---|---|---|---|
| Ink | PR101 | SEC PM | HPP |
| Example Ink | 21.7 | 18.2 | 16.1 |
| Comparative Ink | 31.5 | 26.9 | 22.4 |

Thus, the dyes of the present invention display an unexpected and significantly improved ozone fastness on a number of ink-jet media when compared to a close structural analogue.

### Further Inks

The inks described in Tables A and B may be prepared using the compound of Example 1. Numbers quoted in the second column onwards refer to the number of parts of the relevant ingredient and all parts are by weight. The inks may be applied to a substrate by ink-jet printing.

The following abbreviations are used in Tables A and B:

PG=propylene glycol

DEG=diethylene glycol

NMP=N-methylpyrollidone

DMK=dimethylketone

IPA=isopropanol

MeOH=methanol

2P=2-pyrrolidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE A

| Dye | | | | | | | Na | | | | |
|---|---|---|---|---|---|---|---|---|---|---|---|
| Content | Water | PG | DEG | NMP | DMK | NaOH | Stearate | IPA | MEOH | 2P | MIBK |
| 2.0 | 80 | 5 | | 6 | 4 | | | | | 5 | |
| 3.0 | 90 | | 5 | 5 | | 0.2 | | | | | |
| 10.0 | 85 | 3 | | 3 | 3 | | | | 5 | 1 | |
| 2.1 | 91 | | 8 | | | | | | | | 1 |
| 3.1 | 86 | 5 | | | | | 0.2 | 4 | | | 5 |
| 1.1 | 81 | | | 9 | | 0.5 | 0.5 | | | 9 | |
| 2.5 | 60 | 4 | 15 | 3 | 3 | | | 6 | 10 | 5 | 4 |
| 5 | 65 | | 20 | | | | | 10 | | | |
| 2.4 | 75 | 5 | 4 | | 5 | | | | 6 | | 5 |
| 4.1 | 80 | 3 | 5 | 2 | 10 | | 0.3 | | | | |
| 3.2 | 65 | | 5 | 4 | 6 | | | 5 | 4 | 6 | 5 |
| 5.1 | 96 | | | | | | | | 4 | | |
| 10.8 | 90 | 5 | | | | | | 5 | | | |
| 10.0 | 80 | 2 | 6 | 2 | 5 | | | 1 | | 4 | |
| 1.8 | 80 | | 5 | | | | | | | 15 | |
| 2.6 | 84 | | | 11 | | | | | | 5 | |
| 3.3 | 80 | 2 | | | 10 | | | | 2 | | 6 |
| 12.0 | 90 | | | | 7 | 0.3 | | 3 | | | |
| 5.4 | 69 | 2 | 20 | 2 | 1 | | | | | 3 | 3 |
| 6.0 | 91 | | | 4 | | | | | | 5 | |

TABLE B

| Dye | | | | | | | | | | | |
|---|---|---|---|---|---|---|---|---|---|---|---|
| Content | Water | PG | DEG | NMP | CET | TBT | TDG | BDL | PHO | 2P | PI2 |
| 3.0 | 80 | 15 | | | 0.2 | | | | | 5 | |
| 9.0 | 90 | | 5 | | | | | | 1.2 | | 5 |
| 1.5 | 85 | 5 | 5 | | 0.15 | 5.0 | 0.2 | | | | |
| 2.5 | 90 | | 6 | 4 | | | | | 0.12 | | |
| 3.1 | 82 | 4 | 8 | | 0.3 | | | | | | 6 |
| 0.9 | 85 | | 10 | | | | | 5 | 0.2 | | |
| 8.0 | 90 | | 5 | 5 | | | 0.3 | | | | |
| 4.0 | 70 | | 10 | 4 | | | | 1 | | 4 | 11 |
| 2.2 | 75 | 4 | 10 | 3 | | | | 2 | | 6 | |
| 10.0 | 91 | | | 6 | | | | | | 3 | |
| 9.0 | 76 | | 9 | 7 | | 3.0 | | | 0.95 | 5 | |
| 5.0 | 78 | 5 | 11 | | | | | | | 6 | |
| 5.4 | 86 | | | 7 | | | | | | 7 | |
| 2.1 | 70 | 5 | 5 | 5 | 0.1 | 0.2 | 0.1 | 5 | 0.1 | 5 | |
| 2.0 | 90 | | 10 | | | | | | | | |
| 2 | 88 | | | | | | 10 | | | | |
| 5 | 78 | | | 5 | | | 12 | | | 5 | |
| 8 | 70 | 2 | | 8 | | | 15 | | | 5 | |
| 10 | 80 | | | | | | 8 | | | 12 | |
| 10 | 80 | | 10 | | | | | | | | |

1. A compound of Formula (I) and salts thereof: 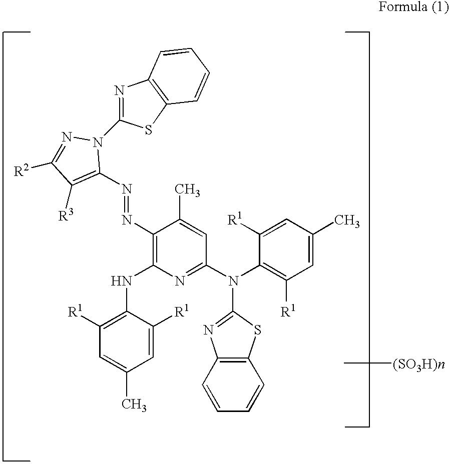
wherein:
R¹ is optionally substituted C₁₋₄alkyl;
R² is optionally substituted aryl;
R³ is CN or SO₂R⁴;
R⁴ is optionally substituted C₁₋₄-alkyl or optionally substituted aryl;
n is 1 to 5.

2. A compound of Formula (I) and salts thereof as claimed in claim 1 wherein R¹ is methyl or ethyl.

3. A compound of Formula (I) and salts thereof as claimed in claim 1 wherein R² is optionally substituted phenyl.

4. A compound of Formula (1) and salts thereof as claimed in claim 1 wherein R² is optionally substituted phenyl carrying optional substituents selected from the group consisting of F, Cl, NO₂, CN, CF₃, —SO₂R^{a} and —SO₂NR^{a}R^{b} wherein R^{a} and R^{b} are each independently H, optionally substituted alkyl or optionally substituted aryl.

5. A compound of Formula (1) and salts thereof as claimed in claim 1 wherein n is 3 or 4.

6. A compound of Formula (1) and salts thereof as claimed in claim 1 wherein R⁴ is optionally substituted C₁₋₄-alkyl or optionally substituted phenyl.

7. A composition comprising a compound of Formula (1) and/or a salt thereof, as described in claim 1, and a liquid medium.

8. A composition as claimed in claim 7 which comprises
(a) from 0.01 to 30 parts of a compound of Formula (1) and salts thereof; and
(b) from 70 to 99.99 parts of a liquid medium;
wherein all parts are by weight.

9. A composition as claimed in claim 7 wherein the liquid medium comprises a mixture of water and organic solvent or organic solvent free from water.

10. A composition as claimed in claim 8 which is ink suitable for use in an ink-jet printer.

11. A process for forming an image on a substrate comprising applying ink suitable for use in an ink-jet printer, according to claim 10, thereto by means of an ink-jet printer.

12. A material printed with a compound as described in claim 1.

13. A material as claimed in claim 12 which is a print on a photographic quality paper.

14. An ink-jet printer cartridge comprising a chamber and ink suitable for use in an ink-jet printer, according to claim 10, wherein the ink is in the chamber.
